(19) United States
(12) Patent Application Publication
(10) Pub. No.: US 2006/0020830 A1
(43) Pub. Date: Jan. 26, 2006

(54) Localisation of image tampering

(76) Inventor: David Keith Roberts, Crawley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/530,498

(22) PCT Filed: Oct. 8, 2003
(86) PCT No.: PCT/IB03/04400

§ 371 Date: Apr. 6, 2005

(30) Foreign Application Priority Data
Oct. 9, 2002 (EP) 02079247.9

(51) Int. Cl. G06F 12/14

(52) U.S. Cl. 713/194

(57) ABSTRACT

A method and device (8) for verifying the authenticity of media content is provided. According to an embodiment accurate tampering location for digital image authentication is provided. Typically, a suspect image is divided into blocks. For each block, an authentication bit is generated by computing a property of the image content and then thresholding said property to give a ‘0’ or ‘1’. The authentication bits of the suspect image are compared with those of the original image. If there is a mismatch, and the content has indeed been tampered, tampering is detected. A mismatch due to allowable operations, such as e.g. compression, is called a false alarm, which should be avoided. A so-called ROC curve (Receiver Operating Characteristic) gives the relation between detection probability and false alarm probability. Preferably, the threshold used to determine the authentication bits represents an operation point on the ROC curve. In accordance with an embodiment of the invention, an operation point corresponding to a low false alarm probability is initially chosen. In order to more precisely identify a tampered image area, the authentication decisions are repeated for neighbouring blocks, using a different operation point. This continues until no further tampered blocks are found. Thus improved tampering localisation is provided, being valuable e.g. to authenticate images captured by e.g. a security camera, and localise any tampered areas, whereby the value of these images is increased as e.g. evidence in a court of law.

### FIELD OF THE INVENTION

This invention pertains in general to the field of digital imaging, and more particularly to authentication of digital images and video, and even more particularly to the identification and localisation of image tampering for authentication purposes.

### BACKGROUND OF THE INVENTION

The ease with which images and video may be edited and altered when in digital form stimulates the need for means to be able to authenticate content as original and unchanged. Where it is judged that an image has been altered, it is also desirable to have an indication of which image areas have been changed.

The authentication problem is complicated by the fact that some image alterations are acceptable, such as those caused by lossy compression. These changes may cause slight degradation of the image quality, but do not affect the interpretation or intended use of the image. The result is that classical authentication techniques from cryptography are not appropriate, as typically these methods would interpret a change of just one bit of an image as tampering.

Generally, there are two approaches for robust, i.e. not bit sensitive, image authentication, namely semi-fragile watermarking, and robust digital signatures that also are known as “fingerprints”. Both of these approaches basically are based on a comparison between a set of bits calculated from the suspect image and the corresponding set of bits calculated from the original image content. Authentication bits are derived from the suspect image, by computing some property, S, of the image pixel values, and then thresholding S to give either a ‘0’ or ‘1’ bit. The computed property depends upon the watermarking or fingerprinting scheme being used. Typically, an image will be divided into blocks and an authentication bit is generated for each block. Examples for a typical block sizes are 16×16 pixels or 32×32 pixels. The subdivision of digital images into blocks allows localisation of image alterations, as an error in a particular bit can be related to an alteration of a particular image region.

For each of the original authentication bits, a decision must be made whether the suspect image is likely to generate a matching authentication bit or not. This equates to judging whether the corresponding image block is authentic or altered. If a block is judged to be tampered, and the image content has indeed been altered, this is called a detection. If, on the other hand, a block is judged tampered when in fact its content has only undergone allowable operations (e.g. compression), the decision is incorrect, and is called a false alarm.

A crude system makes the authentication decision by comparing the bits derived from the suspect image against the original authentication bits. A more sophisticated approach is to use ‘soft decision’ information. In this case the unthresholded values of the property S calculated from the suspect image are used to judge authenticity. Values of S that are on the wrong side of the threshold to generate a bit matching the original authentication bit may still be judged authentic if they are close to the threshold. This gives more robustness to allowable image operations, reducing the probability of false alarms occurring.

### OBJECT AND SUMMARY OF THE INVENTION

It is an object of the invention is to improve the localisation of altered image regions. Thus, a problem to be solved by the invention is to provide a new image authentication method and device, having improved tamper localisation. The present invention overcomes the above-identified deficiencies in the art and solves at least the above-identified problems by providing features according to the appended patent claims.

According to aspects of the invention, a method, an apparatus, and a computer-readable medium for verifying the authenticity of media content are disclosed.

According to one aspect of the invention, a method verifying the authenticity of media content is provided. The method of comprises the following steps, starting with extracting a sequence of first authentication bits from the media content by comparing a property of the media content in successive sections of the media content with a second threshold. Further it comprises receiving a sequence of second authentication bits, wherein the received sequence is extracted from an original version of the media content by comparing said property of the media content with a first threshold. According to the method, the media content is declared authentic if the received sequence of second authentication bits matches the extracted sequence of first authentication bits. The method is characterised in that the step of extracting the authentication bits from the media content comprises setting the second threshold in dependence upon the received authentication bits, such that the probability of an extracted authentication bit in said sequence of first authentication bits mismatching the corresponding received authentication bit in said sequence of second authentication bits is reduced compared with using the first threshold for said extraction.

According to another aspect of the invention, a device for verifying the authenticity of media content by performing the above method according to one aspect of the invention is provided by the respective appended independent claim.

According to a further aspect of the invention, a computer-readable medium having embodied thereon a computer program for verifying the authenticity of media content by performing the above method according to claim 1, and for processing by a computer, is provided by the respective appended independent claim.

According to one embodiment of the invention, “context” information is used in the authentication decision of multimedia content, such as digital images or video. The multimedia content is divided into segments, such as blocks, and the “context” information is derived for each block. More particularly, the number and location of blocks, which are declared tampered affects the decisions about which other blocks may be tampered. For example, blocks neighbouring a tampered block are under greater suspicion than blocks further away. According to one embodiment of the invention, this context information is incorporated into the authentication decisions by adjustments to the operating point on a so-called ROC curve (Receiver Operating Characteristic), which will be explained in more detail below.

According to an embodiment of the invention, an authentication check for an image comprises the following steps:
1. An authentication decision is made for each block independently using a low false alarm operating point.
2. If no blocks are declared tampered, then the image is taken as authentic.
3. If one or more tampered blocks are found then it is known that the image as a whole is inauthentic. This means that blocks neighbouring those that are tampered are also likely to be tampered, and all other image blocks can be assumed equally likely to be authentic or tampered. Knowing this, new operating points are selected for each block's authentication decision.
4. The authentication decisions for all blocks not yet declared tampered are re-evaluated using the new decision boundaries.
5. If further blocks are declared tampered, the procedure of adjusting the decision boundaries and re-evaluating blocks' authenticity is repeated. This continues until no further tampered blocks are identified.

Alterations to the decision boundary may be used to move the operating point to a position with a larger detection probability. This may find further tampered blocks, and thus help determine the filil size and shape of the tampered image region.

The present invention has the advantage over the prior art that it provides an improved localisation of tampered regions during authentication of digital images.

The invention is applicable irrespective of whether the authentication bits, as described above, constitute a watermark or a fingerprint.

### BRIEF DESCRIPTION OF THE DRAWINGS

Further objects, features and advantages of the invention will become apparent from the following description of embodiments of the present invention, reference being made to the accompanying drawings, in which

FIG. 1 is a schematic illustration of a typical surveillance system,

FIG. 2 is a graph showing an example ROC curve relating to tamper detection and false alarm probabilities,

FIG. 3 is an image showing an authentic untampered sample image,

FIG. 4 is an image showing the sample image of FIG. 3 with a region being tampered,

FIG. 5 is an image showing the tampered sample image of FIG. 4 with blocks being judged as tampered according to a prior art tampering judgement,

FIG. 6 is an image showing the sample image of FIG. 4 with blocks being judged as tampered according to the present invention,

FIG. 7 is a flowchart illustrating an embodiment of the method according to one aspect of the present invention,

FIG. 8 is a schematic illustration of an embodiment according to another aspect of the present invention,

FIG. 9 is a schematic illustration of an embodiment according to yet another aspect of the present invention,

FIG. 10 is a graph showing two conditional probability density functions (PDF), under two different hypothesis,

FIG. 11 is a graph illustrating the false alarm probability for a JPEG image, and

FIG. 12 is a graph illustrating the probability of tamper detection for 1 fingerprint bit per 32×32 pixel block.

### DESCRIPTION OF EMBODIMENTS

The invention is described below in detail by means of embodiments described with reference to a surveillance system. However, the invention is by no means limited to these exemplary embodiments referring to the mentioned surveillance system, and the person skilled in the art will readily be aware of modifications and other applications within the scope of the appended independent patent claims.

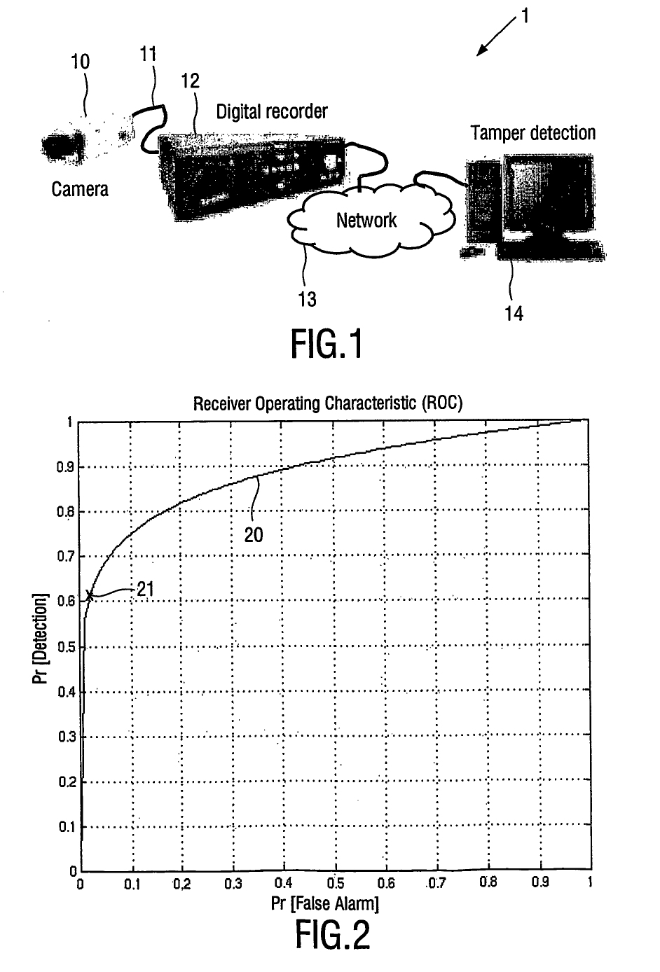

FIG. 1 illustrates the layout of a typical surveillance system 1. This consists generally of the following components:
at least one video camera 10, having a video output 11 that usually is in an analogue format, such as PAL or NTSC,
a digital recorder 12, which takes the video inputs from multiple cameras 10 and applies lossy compression, and
a computer network 13 providing storage and retrieval, and
authentication means 14 for the compressed video.

A variety of compression methods are in use in surveillance systems 1, including both spatio-temporal (e.g. MPEG), and still-image techniques (e.g. JPEG, ADV601). Where still-image compression is applied, compression in the temporal direction is achieved by retaining, for example, only one image every 5 seconds. Note that the distortions to the video that result from lossy compression by the digital recorder 12 must not be mistaken for tampering.

The envisaged type of media content tampering, which is to be detected and precisely localised by the disclosed embodiments of invention, is pixel replacement in digital images. For example, this could be the removal of a person by replacement with e.g. “background” content, perhaps copied from an earlier/later image in which the person is absent, so that the over-all content of the image in question appears to be correct, or any other pixel modification changing the visual content of said image. However allowable operations, such as image compression to save storage space, are not to be classified as tampering.

A guideline for the minimum detectable size of tampered region is the minimum size at which a human face is recognisable. This size is approximately 35 pixels wide and 50 pixels high for PALJNTSC video content.

Generally, tamper detection proceeds by comparing authentication data derived from the suspect image with the corresponding data derived from the original image, as mentioned above. This may be decomposed into two sub-problems:
how to generate appropriate authentication data, and
how to transport the authentication data of the original image to the point in the system where authenticity is tested.

At the camera 10 it is not known whether the recorder 12 will discard images during compression. The authentication data must therefore be generated and transported such that each image may be authenticated independently, without reference to images at any other point in time.

In addition, the ability to distinguish between allowable and malicious alterations is usually referred to by the term semi-fragile. Generally, there are two alternative authentication solutions depending upon where this fragility is located:
1. Semi-fragile watermarks, wherein the transport of the original image's authentication data is such that it can be correctly retrieved after allowable alterations, but not after tampering, and
2. Semi-fragile digital signatures, wherein the generation of the authentication data is such that the data is invariant to allowable alterations, but not to tampering.

Semi-fragile watermarking usually generates a fixed pattern of bits for the authentication data, and then embeds these using a semi-fragile technique. Authenticity checking consists of extracting the watermark bits and comparing them against the pattern that was embedded. The locality of tampered image regions is indicated by errors in the extracted authentication bits.

The use of a fixed pattern of embedded bits facilitates the creation of apparently authentic tampered images. For example, pixels may be replaced by content copied from the same location in a different, but authentic, image. Extraction of the watermark bits will still be successful, and so the altered image will be judged authentic.

Security may be increased by generating the authentication bits such that they are dependent upon the image content. This helps preventing the copy attack example given above. If the content dependent watermark bits also possess fragility to tampering, then such a scheme has properties of both semi-fragile watermarking and semi-fragile signatures. If, for example, the authentication data and watermark are fragile to different types of image alterations, then this approach helps to indicate what type of tampering has taken place.

However, semi-fragile watermarking can only protect the image features (e.g. pixels or frequency coefficients) that are used for embedding the authentication data. Protecting the most perceptually important image features therefore requires data to be embedded into these features. This may present difficulties in ensuring watermark invisibility. Any image material in which watermark bits cannot be both invisibly embedded and reliably detected, such as flat content, will result in bit errors even without tampering. There is no way to distinguish these bit errors due to zero watermark capacity from those due to tampering. The replacement of original image regions by flat content may therefore create an apparently authentic tampered image.

One attempt is made to overcome this last-mentioned problem via ‘backup embedding’. Herein, each watermark bit is embedded twice, using two spatially separate embedding locations. However, there is no guarantee that the backup location does not also have zero watermark capacity. Embedding each authentication bit multiple times must also have negative implications for either the tamper localisation ability due to fewer authentication bits for a given embedding capacity, or for invisibility and robustness to allowable operations due to an increased number of embedded bits.

Generally, a digital signature is a set of authentication bits that summarise the image content. A semi-fragile signature is generated in such a way that a tampered image gives a changed set of summary bits, but an image processed only by allowable manipulations does not. This non bit-sensitive type of signature will be referred to as a fingerprint in order to provide a clear distinction from cryptographic digital signatures, and highlight the relevance to other applications.

The image features from which fingerprint bits are calculated are generally chosen to give the most appropriate trade-off between robustness to allowable processing, fragility to tampering, and computational cost. Examples for these features are DC values, moments, edges, histograms, compression invariants, and projections onto noise patterns.

Authenticity is verified by comparing the fingerprint generated from the suspect image, with the original fingerprint calculated e.g. in the camera. Typically, a direct relationship exists between individual fingerprint bits and an image location. For example, the image may be split into blocks and a bit derived for each block. The locality of tampered image regions is therefore indicated by which particular fingerprint bits are in error.

However, there is a trade-off between the number of fingerprint bits and the localisation ability. For example, a smaller block size allows better localisation of tampered areas, but there are more blocks per image, and thus more fingerprint bits.

Having generated a fingerprint of the original image in the camera, there remains the problem of transporting this fingerprint data, such that it is available at authenticity verification.

One possibility is to embed the fingerprint bits into the image as a watermark, as mentioned above. Watermarking provides a solution to the transport problem. By invisibly embedding the fingerprint into the image, this data is automatically carried with the image. Clearly the watermark must be robust to at least all allowable image processing. If the watermark is also semi-fragile, this may aid identification of the type of tampering that has occurred, as explained above. The content dependent nature of the fingerprint bits also helps prevent watermarked content copied from one image to another from appearing authentic.

A fingerprint protects against alteration of the image features used to calculate the fingerprint bits. These features may be different from those used to embed the fingerprint as a watermark. This gives increased flexibility to embed bits in the most appropriate manner for invisibility and robustness requirements, and helps avoid the zero watermark capacity problems from which semi-fragile watermarking authentication schemes suffer.

A drawback of transporting fingerprint data using a watermark is that this may limit the tamper localisation ability. A sufficiently robust watermark will typically have a very limited payload size, which may place an unacceptable constraint upon the fingerprint size, and hence upon the localisation ability.

Transporting fingerprint data separate from the video is not possible due to the analogue cable between the camera 10 and recorder 12. This requires that the authentication data generated in the camera must be embedded into the video signal itself for transmission to the recorder. An alternative to watermarking is thus to embed the fingerprint data directly into the pixel values, in a manner similar to teletext data in television signals. Security cameras already transport camera parameters, control information, and audio using such data channels. The data carrying capacity of these data channels can be far greater than a watermark, depending upon how many video lines are utilised. If only video lines in the over-scan area, i.e. the vertical blanking interval, are employed, then invisibility of the embedded data is maintained.

It is important that fingerprint data is encrypted before it is embedded in this manner. Without encryption, substitution of the original fingerprint data with a fingerprint corresponding to a tampered image would make the forgery appear authentic. Missing or damaged authentication data must always be interpreted as tampering.

Fingerprints should be calculated based upon the low frequency content of the image. This is necessary to provide resilience to the analogue link, which severely limits the video signal bandwidth, and lossy compression, which typically discards the higher frequency components.

In applications where the allowable processing operations are well characterised, this knowledge may be utilised in fingerprint calculation. For example, properties that are invariant to JPEG quantisation are used to form fingerprints. However, due to the wide variety of compression methods used in surveillance systems, as mentioned above, such an approach is not possible.

Moreover, the camera 10 must calculate and embed authentication data in real-time for each and every output image, as already mentioned above. This places severe constraints upon the computational load if the impact upon the camera cost is to be minimised.

A low frequency and low complexity fingerprint may be formed by utilising only the DC component. The image is divided into blocks, and differences between blocks' DC values, i.e. the mean pixel luminance, are used to form the fingerprint. Using DC differences provides invariance to changes in the overall image DC component, e.g. due to brightness alterations. Taking differences between the DC values of adjacent blocks captures how the image content of each block relates to its neighbours. According to a specific example, a fingerprint bit bᵢ is derived for the i^{th} block as follows:

$${s}_{i} = {\sum }_{j = 1}^{8} ( {DC}_{i} - {DC}_{j} ) \qquad ( 1 )$$

bᵢ=1 if sᵢ>0, bᵢ=0 otherwise,
   where j indexes eight blocks that neighbor block i.

The appropriate block size is related to the size of image feature upon which tamper detection is desired. Smaller blocks increase the likelihood of alterations being detected, but at the cost of an increased number of fingerprint bits to calculate and transport.

The most straight-forward approach to checking authenticity is a simple bit by bit comparison of the original and suspect authentication bits. This alone, however, is unlikely to be satisfactory, as some bit errors due to allowable processing are almost inevitable.

Methods to solve this problem are often based upon the observation that these bit errors due to allowable processing are likely to be lightly distributed over the whole image, whereas bit errors due to tampering are likely to be concentrated in a confined area. Allowable operations may therefore be distinguished from tampering via a post-processing operation upon the bit errors, such as error relaxation, or mathematical morphology.

In general, authenticity verification affords more complex computation than fingerprint calculation, as it occurs relatively infrequently, needs not be real-time, and has a more powerful computation platform available.

Rather than applying an ‘after-thought’ post-processing step to provide resilience to allowable processing, it is preferable to build this robustness more closely into the authenticity decision. This may be achieved by using ‘soft-decision’ information during comparison of the suspect image's fingerprint with the original fingerprint bits. This prevents tampering from being indicated in cases where sᵢ is close to zero, and therefore a fingerprint bit error is likely to occur due to allowable processing.

According to a further embodiment, the authenticity decision for an individual block may be expressed as a choice between hypothesis H₀, i.e. the block's image content is authentic, and hypothesis H₁, i.e. the block's image content has been tampered with. The basics of hypothesis theory are given in the appendix, which is part of this description. Given the value s of the block, computed according to Equation 1, and the fingerprint bit of the original image b_{orig}, the hypothesis with the greatest probability is chosen:

If Pr[H₀|b_{orig}, s]>Pr[H₁|b_{orig}, s], choose H₀
but, from Bayes theorem:

$$Pr [ {H}_{0} \vert {b}_{orig} , s ] = \frac{{p}_{S \vert {H}_{0} , {b}_{orig}} ( s ) Pr [ {H}_{0} ]}{{p}_{S} ( s )}$$

and similarly for H₁, so the decision rule becomes:

$$If \frac{{p}_{S \vert {H}_{0} , {b}_{orig}} ( s )}{{p}_{S \vert {H}_{1} , {b}_{orig}} ( s )} > \frac{Pr [ {H}_{1} ]}{Pr [ {H}_{0} ]} , choose {H}_{0} \qquad ( 2 )$$

It is difficult to assign values to the prior probabilities of each hypothesis, as this would be equivalent to stating what proportion of images are tampered, so the Neyman-Pearson decision rule (as explained in the appendix) is more appropriate. This approach maximises the probability of tampering being detected for a fixed ‘false alarm’ probability of allowable processing being mistaken for tampering. In practice this results in the priors being replaced by a threshold λ, which is set to achieve the desired false alarm rate:

$$If \frac{{p}_{S \vert {H}_{0} , {b}_{orig}} ( s )}{{p}_{S \vert {H}_{1} , {b}_{orig}} ( s )} > λ , choose {H}_{0} \qquad ( 3 )$$

If hypothesis H₁ is true, then we have no knowledge of the replacement content and may only assume that the result of Equation 1 is distributed as for image content in general, i.e. P_{S|H}_{₁}_{,b}_{_{orig}}(s)=p_{S}(s).

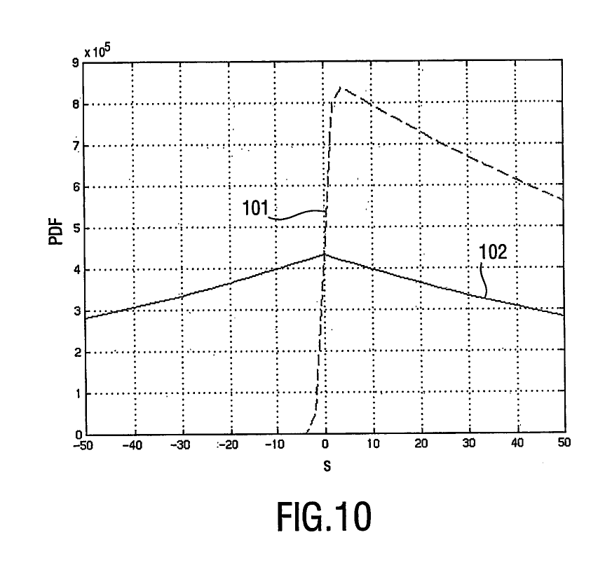

The probability density function (PDF) p_{S}(s) has been estimated from a set of images, and turns out to be well approximated by a laplacian distribution, as shown in FIG. 10.

If hypothesis H₀ is true, then the outcome of Equation 1 for the original image, S_{orig}, is of known sign, given by the value of b_{orig}. The distribution of S_{orig} is therefore the one-sided version of p_{S}(s), i.e. exponential. Allowable processing operations then cause an error E, resulting in the observed value S=S_{orig}+E. The distribution of E should be estimated for the harshest allowable processing to which images will be subject, e.g. the lowest JPEG quality factor. Typically a gaussian distribution provides a reasonable approximation to the PDF of E. Finally, assuming independence of S_{orig} and E, the following convolution gives the PDF required for the hypothesis test:

$${p}_{S \vert {H}_{0} , {b}_{orig}} ( s ) = {\int }_{- ∞}^{∞} {p}_{{S}_{orig}} ( s - e ) {p}_{E} ( e ) ⅆ e$$

FIG. 10 shows a plot 101 of this PDF for the case of E corresponding to JPEG compression of quality factor 50, and b_{orig}=1. Note the deviation from the exponential shape, which is due to E. This gives non zero probabilities of S being negative, and thereby models fingerprint bit errors due to allowable processing.

From FIG. 10 results that, whatever the value of the threshold A, the PDFs only cross at a single point. The hypothesis test therefore reduces to a simple threshold test on blocks' values of S. The threshold value ST for b_{orig}=1 satisfies:
p_{S|H}_{₀}_{,b}_{_{orig=1}}(s_{T})=λ_{S|H}_{₁}(s_{T})
and, by symmetry, the threshold for b_{orig}=0 is −s_{T}.

FIG. 11 illustrates the false alarm probability for a JPEG image. It is clear from graph 111 that a feature S possessing a less peaked PDF is desirable. This would reduce the smearing over the bit threshold due to E, giving fewer fingerprint bit errors due to allowable processing.

Note that the above derivations assume that values of S are independent and identically distributed for different blocks. In practice this is not always true, and some correlation exists between values of S for adjacent blocks. Nevertheless, as will be seen in the results given below, the approach is very useful.

An advantage of the above hypothesis test framework is that it allows the possibility of errors in the original fingerprint bits to be taken into account. This is achieved by making the value of b_{orig} a random variable distributed according to the bit error rate of the transport channel.

A further advantage of the present invention is that improvements in the localisation of tampered areas are possible by adjusting the operating point, i.e. the threshold A. Normally A is set to achieve the desired low false alarm rate. However, once one or more blocks are identified as tampered, the image as a whole is known to be inauthentic, and each individual block may be considered equally likely to be tampered or authentic. This points towards re-evaluating the authenticity decision for all blocks using equal prior probabilities, i.e. A=1. This approach may be taken even further by taking the spatial distribution of tampered blocks into account. For example, a block with several tampered neighbouring blocks is also likely to be tampered. These beliefs may be expressed by modifying the prior probabilities, or equivalently, the value of Z. Experiments have shown that these adjustments of the operating point and re-evaluation of authenticity decisions help extract the size and shape of the tampered region with greater accuracy.

Setting exactly which range of values of S will be classified as authentic, and which as tampered, fixes the false alarm and detection probabilities. According to where the decision boundary is placed, different trade-offs between the detection and false alarm probabilities may be achieved. This is often displayed in a Receiver Operating Characteristic (ROC). A typical shape of an ROC curve is displayed in the graph 20 in FIG. 2.

In image authentication, it is expected that only a small minority of images will actually be tampered. It is therefore important to have a low probability of false alarm, otherwise large numbers of authentic images will be declared tampered. The operating point on the ROC curve will therefore usually be chosen to give an acceptably small false alarm rate.

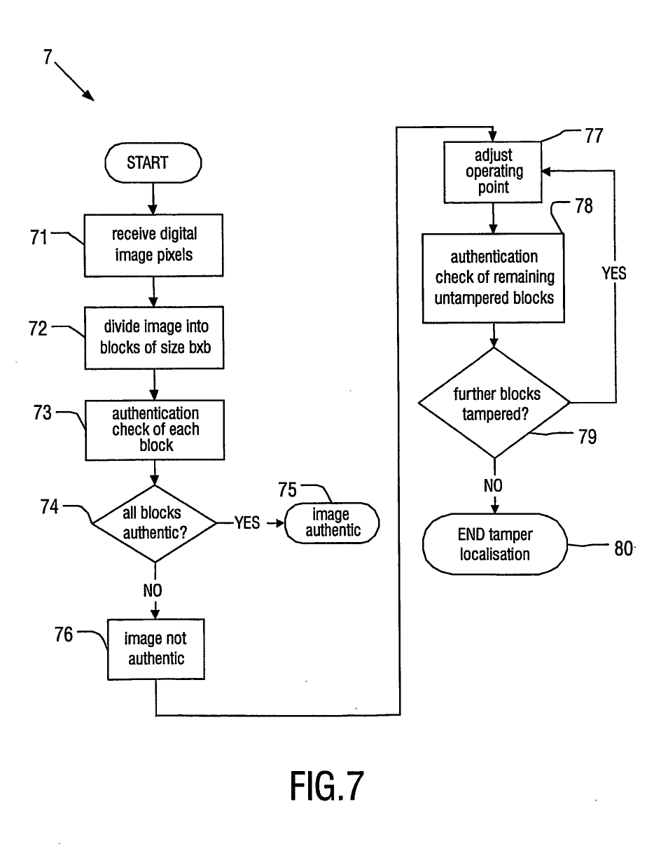

According to one embodiment of the invention, illustrated in FIG. 7, this context information is incorporated into the authentication decisions by adjustments to the operating point on the above-explained ROC curve. According to that embodiment of the invention, a method 7 for authentication checking a digital image is provided, wherein the method 7 comprises the following steps.

In step 71 a digital image is received. The purpose of method 7 is to establish if the image is authentic, and if not, to accurately locate the spatial position of the tampered area or areas. For this purpose, the image is divided into blocks, e.g. of size b×b pixel, according to step 72. In step 73 an authentication decision is made for each block independently using a low false alarm operating point on the ROC curve. In the exemplary ROC shown in FIG. 2, an exemplary operation point flfilling these conditions is marked by an “X” 21 on graph's 2 ROC curve.

If no blocks are declared tampered in step 74, then the image is taken as authentic in step 75. If one or more tampered blocks are found then it is known that the image as a whole is inauthentic, as illustrated in step 76. This means that blocks neighbouring those that are detected as tampered in step 73 are also likely to be tampered, and all other image blocks can be assumed equally likely to be authentic or tampered. Knowing this, new operating points on the ROC curve are selected in step 77 for each of the remaining block's authentication decision. The authentication decisions for all blocks not yet declared tampered are re-evaluated in step 78 using the new decision boundaries.

If further blocks are declared tampered in step 78, the procedure of adjusting the decision boundaries and re-evaluating blocks' authenticity is repeated, according to the decision taken in step 79. This loop continues until no further tampered blocks are identified.

Alterations to the decision boundary may be used in the repeated step 77 to move the operating point to a position with a larger detection probability. This may find further tampered blocks, and thus help determine the full size and shape of the tampered image region.

Selecting an operating point that gives a low false alarm probability also reduces the detection probability, as illustrated in FIG. 2. This means that many tampered blocks will not be detected. Assuming that the tampered region spans multiple authentication blocks, then the probability of all of the altered blocks not being detected is much smaller, so the fact that the image is inauthentic will still be apparent.

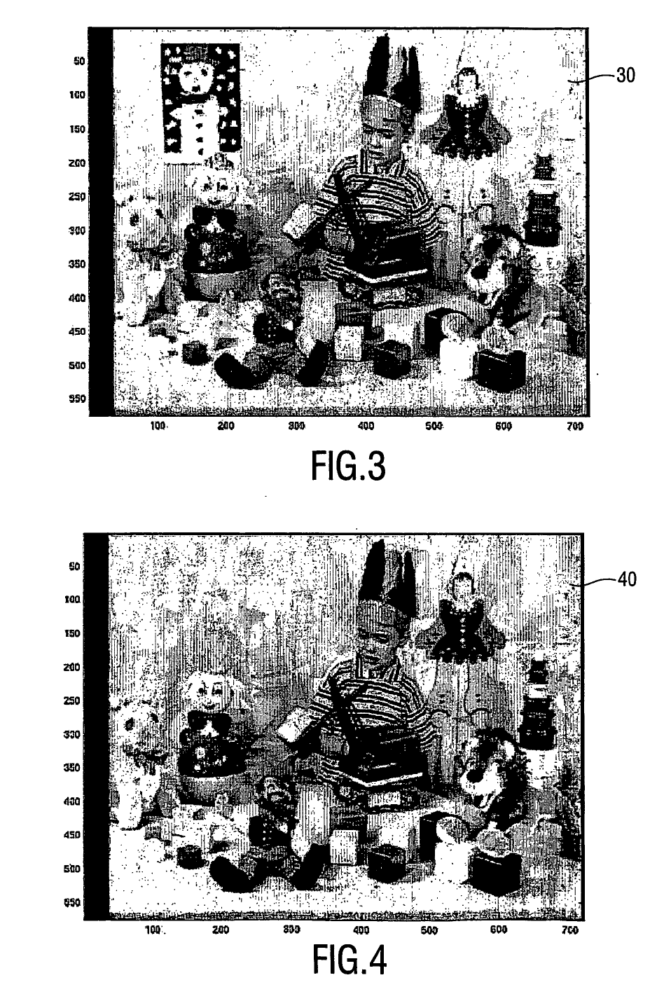

Although a low false alarm operating point can still achieve a good probability of detecting whether images have been altered, it has more serious implications for the localisation of image alterations. The low detection probability for individual blocks leads to a patchy detection of which image regions have been changed. This is illustrated in the Figures that follow: FIG. 3 shows the original image 30, and FIG. 4 the altered version 40; FIG. 5 shows an image 50 in which authentication blocks are judged as tampered (blocks in the upper left region of the image).

It can be seen in FIG. 5 that numerous image blocks are judged as tampered, so it is clear that the image is inauthentic. However, comparison between FIGS. 3, 4, and 5 illustrates the patchy detection of the tampered image area; the full size and shape of the altered image region is not readily apparent.

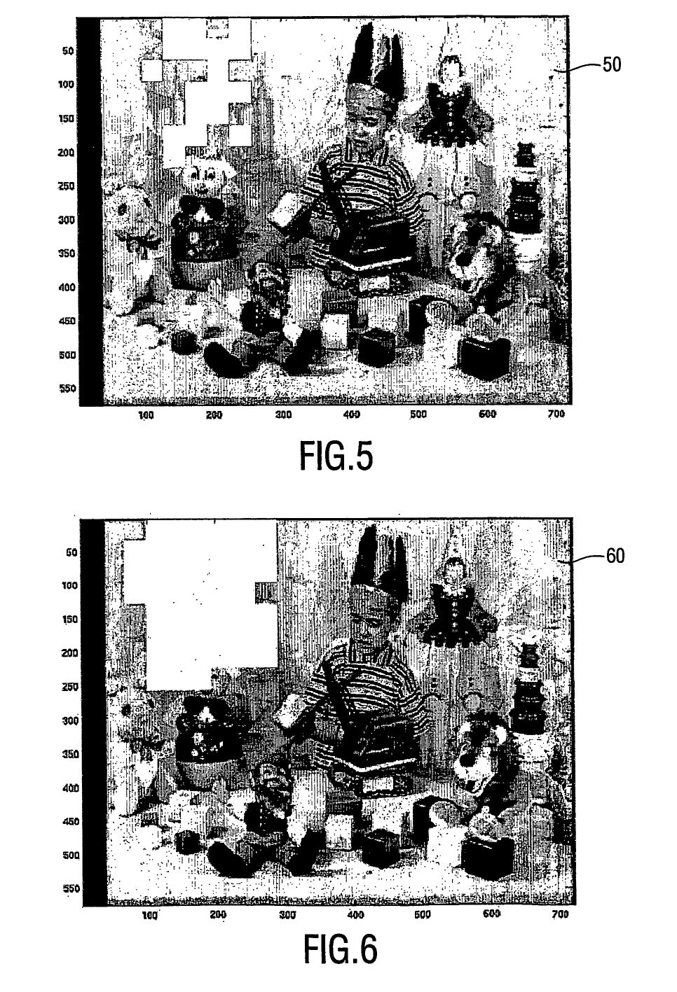

Applying method 7 to the example shown in FIG. 4, provides the result shown in the image 60 of FIG. 6. The much fulller coverage and localisation of the tampered region is evident, when comparing the result with the detection shown in FIG. 5.

Using a decision framework, as described in the appendix, the invention may be applied in a further embodiment as follows.

An operating point λ₀ is chosen that gives an acceptably low false alarm rate. The authenticity of all image blocks is assessed using this decision threshold

If no blocks are declared tampered, then the image is taken as authentic

If one or more tampered blocks are found, then for all other blocks i, a new operating point λᵢ is determined. This adjustment of the decision threshold will take into account the number of tampered blocks found, as well as their proximity to the block i.

Many algorithms for adjusting the decision threshold are possible. One non-limiting example is:
λᵢ=αλ₁+(1−α)λ₂,
where λᵢ=1, this represents equal prior probabilities, λ₂>1, this gives a higher detection probability, and α is given by:

$$α = ( \frac{n}{8} ) ( \frac{ⅆ - rm}{ⅆ - 1} ) , and {r}_{m} = min ( r , d )$$

where n is the number of exemplary 8 blocks neighbouring block i that are marked as tampered, r is the distance (in units of blocks) of block i from the closest tampered block, and d is some maximum distance that sets how widely around a tampered block that suspicion is raised.

The authentication decisions are re-evaluated using the new decision boundaries λᵢ.

If further blocks are declared tampered, the procedure of adjusting the decision boundaries and re-evaluating blocks' authenticity is repeated. This continues until no further tampered blocks are identified.

This exemplary description of the further embodiment makes it clear that adjusting the operating point is equivalent to adjusting the prior probability of a block being tampered. This in turn is justified by the block's context, i.e. its location with respect to other tampered areas.

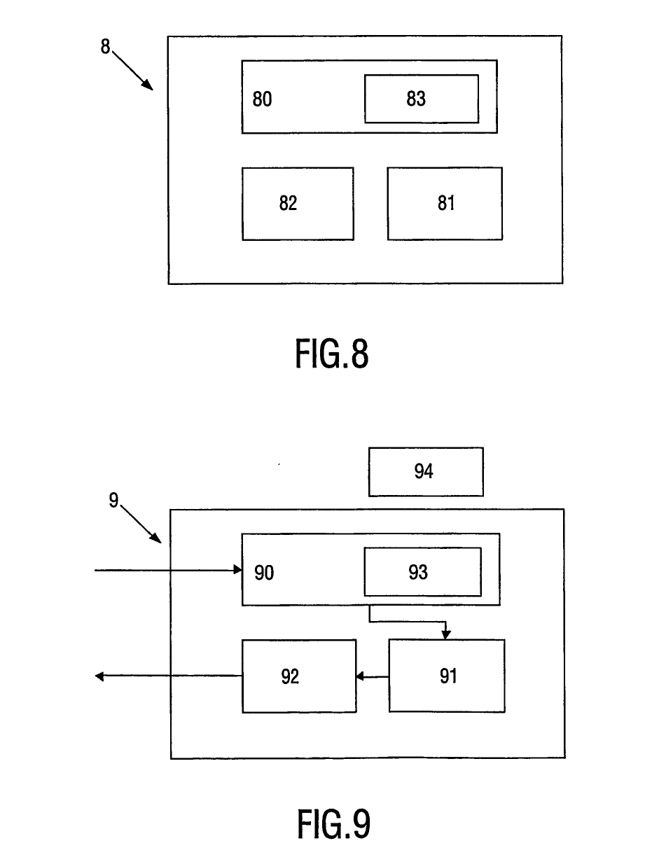

A further embodiment of another aspect of the invention is illustrated in FIG. 8, wherein a device 8 for verifying the authenticity of media content comprises means for performing the authentication method according to one aspect of the invention.

More precisely, the device 8 is a device for verifying the authenticity of media content. The device 8 comprises first means 80 for extracting a sequence of first authentication bits from the media content by comparing a property of the media content in successive sections of the media content with a second threshold. Furthermore the device 8 comprises means 81 for receiving a sequence of second authentication bits, wherein said received sequence is extracted from an original version of the media content by comparing said property of the media content with a first threshold. In addition, device 8 has means 82 for declaring the media content authentic if the received sequence of second authentication bits matches the extracted sequence of first authentication bits. The device 8 is characterised in that the means 80 for extracting the authentication bits from the media content comprise means 83 for setting the second threshold in dependence upon the received authentication bits, such that the probability of an extracted authentication bit in the sequence of first authentication bits mismatching the corresponding received authentication bit in the sequence of second authentication bits is reduced compared with using the first threshold for said extraction. Device 8 is e.g. integrated into authentication means 14 shown in FIG. 1.

In another embodiment of the invention according to FIG. 9, according to a further aspect of the invention, a computer-readable medium 9 having embodied thereon a computer program for verifying the authenticity of media content by performing the method according to one aspect of the invention and for processing by a computer 94 is provided. The computer program comprises several code segments for this purpose. More precisely, the computer program on the computer-readable medium 9 comprises a first code segment 90 for extracting a sequence of first authentication bits from the media content by comparing a property of the media content in successive sections of the media content with a second threshold. Furthermore the computer program comprises a code segment 91 for receiving a sequence of second authentication bits, wherein said received sequence is extracted from an original version of the media content by comparing said property of the media content with a first threshold. In addition, the computer program has a code segment 92 for declaring the media content authentic if the received sequence of second authentication bits matches the extracted sequence of first authentication bits. The computer program is characterised in that the code segment 90 for extracting the authentication bits from the media content comprises a code segment 93 for setting the second threshold in dependence upon the received authentication bits, such that the probability of an extracted authentication bit in the sequence of first authentication bits mismatching the corresponding received authentication bit in the sequence of second authentication bits is reduced compared with using the first threshold for said extraction.

The above computer program is e.g. run on a authentication means 14 as shown in FIG. 1.

The performance of an authentication system may be measured by its probability of detecting tampering, and its false alarm probability when only allowable image processing has been applied. Few publications provide this information, usually giving only one example image on which the authentication method is demonstrated. The detection probability in particular is difficult to assess as it requires the tampering of a large number of images, and manually replacing sections of an image in a convincing way is very time consuming.

To overcome this, the detection rate has been estimated by an automatic process that blends image content from a second unrelated image into the image under test. Many trials are performed, using different test images, different tampered locations, and different replacement image content. The whole test is also repeated for different sizes of tampered area in order to gain a full picture of the performance of the authentication method according to the invention.

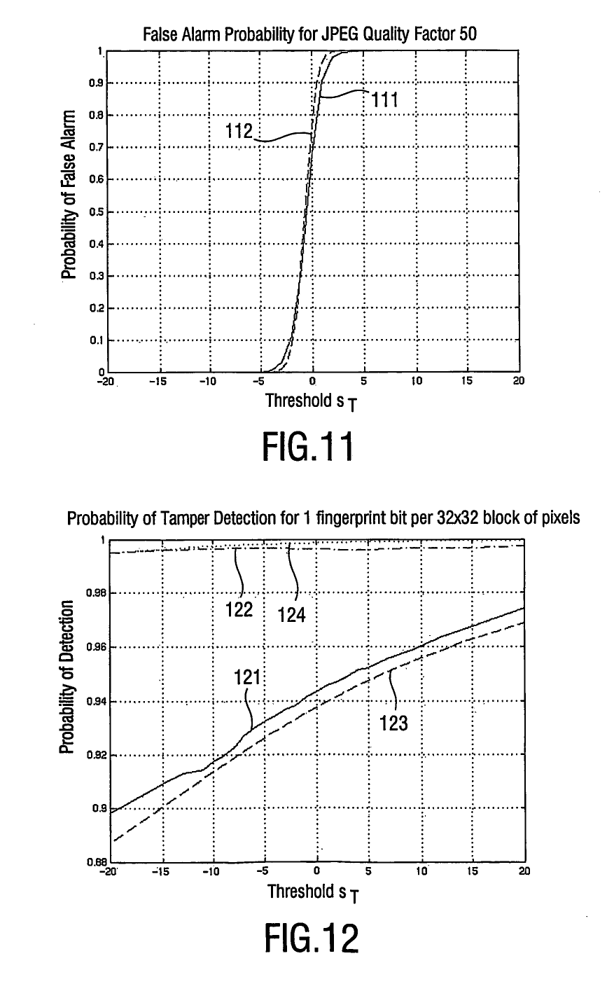

The measured false alarm and detection probabilities using this ‘simulated tampering’ are given in FIGS. 11 and 12 as a function of the decision threshold ST. The presented results are for a fingerprint of 1 bit per 32×32 block of pixels, and allowable processing of JPEG quality factor 50. FIG. 11 shows that the false alarm probability exhibits the expected transition around the fingerprint bit threshold of S=0. The sharpness of the transition is due to the high robustness of the property S to JPEG compression, and consequently small chance of allowable processing causing fingerprint bit errors. FIG. 12 shows graph 121 and 122 illustrating the detection probability for two different sizes (64×64 and 100×100, respectively) of tampered area as experimentally found. It is clear that for good detection rates, the fingerprint block size is required to be smaller than the minimum size of tampered area that it is wished to detect.

The performance of the authentication system may also be estimated theoretically using the probability distributions derived in the previous section. The detection and false alarm probabilities for an individual block are:

$$Pr ( D ) = {\int }_{- ∞}^{{S}_{T}} {p}_{S \vert {H}_{1}} ( s ) ⅆ s = {\int }_{- {S}_{T}}^{∞} {p}_{S \vert {H}_{1}} ( s ) ⅆ s$$

$$Pr ( FA ) = {\int }_{- ∞}^{{s}_{T}} {p}_{S \vert {H}_{0} , {b}_{orig} = 1} ( s ) ⅆ s = {\int }_{- {S}_{T}}^{∞} {p}_{S \vert {H}_{0} , {b}_{orig} = 0} ( s ) ⅆ s$$

Assuming the individual block decisions to be independent, the false alarm probability for the entire image may be estimated as:
Pr(FalseAlarm)=1−(1−Pr(FA))^{N}
where N is the number of fingerprint blocks in the image. This is plotted as graph 112 in FIG. 11 and can be seen to show good correspondence with the experimental results 111. This justifies using the theoretical approach to calculate the value of ST to be used in practice, where a false alarm rate too low to be simulated in a reasonable time is required.

The detection probability for the whole image may similarly be estimated by:
Pr(Detection)=1−(1−Pr(D))^{M}

However, setting the value of M, the number of tampered blocks, is problematic as it is dependent upon the size and shape of the tampered region with respect to the fingerprint blocks. In FIG. 12 the detection probabilities are estimated by setting:

$$M = \frac{{n}^{2}}{{b}^{2}} ,$$

where the tampered area is a block of n×n pixels, and the fingerprint is formed using blocks of b×b pixels. Graphs 123 and 124 show the theoretical results for the two different sizes (64×64 and 100×100, respectively) of tampered area. This can be seen to give a reasonable match to the experimental results, and is thus a useful estimation of the detection rate when setting the decision threshold.

The sum of this disclosure is that a fingerprinting solution for security camera video authentication are described above. Fingerprints based upon block DC differences are shown to give a good trade between compression robustness, sensitivity to tampering, and computational cost. Further, a hypothesis test approach to authenticity verification is disclosed. This offers a number of advantages of, such as tolerance to fingerprint bit errors caused by allowable processing; the ability to cope with bit errors in the received original fingerprint; and improved localisation of tampering by adjustment of the prior probabilities. However, this security camera solution is merely a non-limiting example of the present invention as defined in the appended patent claims. Moreover, the embodiments illustrated above by means of security cameras are similarly non-limiting examples.

At last, the above is summarised in that an accurate tampering location for digital image authentication is provided. Typically, a suspect image is divided into blocks. For each block, an authentication bit is generated by computing a property of the image content and then thresholding said property to give a ‘0’ or ‘1’. The authentication bits of the suspect image are compared with those of the original image. If there is a mismatch, and the content has indeed been tampered, tampering is detected. A mismatch due to allowable operations, such as e.g. compression, is called a false alarm, which should be avoided. A so-called ROC curve (Receiver Operating Characteristic) gives the relation between detection probability and false alarm probability. The threshold used to determine the authentication bits represents an operation point on the ROC curve. In accordance with an embodiment of the invention, an operation point corresponding to a low false alarm probability is initially chosen. In order to more precisely identify a tampered image area, the authentication decisions are repeated for neighbouring blocks, using a different operation point. This continues until no furtier tampered blocks are found. Thus improved tampering localisation is provided, being valuable e.g. to authenticate images captured by e.g. a security camera, and localise any tampered areas, whereby the value of these images is increased as e.g. evidence in a court of law.

Note that the concept of adjusting the operating point on the ROC curve, and re-evaluating decisions in the light of neighbouring decisions, is of value not only in image or video or audio authentication, but is equally applicable to other fields where many inter-related decisions have to be taken.

Applications and use of the above-described aspects of the invention are various and include exemplary fields such as the above-mentioned application in the field of surveillance camera systems.

The present invention has been described above with reference to specific embodiments. However, other embodiments than the preferred above are equally possible within the scope of the appended claims, e.g. different ways of generating the stored authentication information than those described above, performing the above method by hardware or software, etc.

Furthermore, the term “comprises/comprising” when used in this specification does not exclude other elements or steps, the terms “a” and “an” do not exclude a plurality and a single processor or other units may fulfil the functions of several of the units or circuits recited in the claims.

Appenddx—Hypothesis Tests

Given the value of the property S calculated for the suspect image block, the hypothesis that the block is tampered (H₁) is selected if this has a greater probability than the hypothesis that the block is authentic (H₀):
Select H₁ if: Pr(H₁/S=s)>Pr(H₀/S=s)

Expanding this in terms of the probability density functions of S, and the prior probabilities of each hypothesis gives:
Select H₁ if:

$$\frac{p ( s / {H}_{1} ) Pr ( {H}_{1} )}{p ( s )} > \frac{p ( s / {H}_{0} ) Pr ( {H}_{0} )}{p ( s )}$$
Rearranging:
Select H₁ if

$$\frac{p ( s / {H}_{1} )}{p ( s / {H}_{0} )} > \frac{Pr ( {H}_{0} )}{Pr ( {H}_{1} )}$$

The difficulty with this decision process is setting the values of the prior probabilities, Pr(H₁) (the probability that any given image is tampered), and Pr(H₀) (the probability that any given image is authentic). These probabilities are unlikely to be known, so instead their ratio may be represented by a value λ:
Select H₁ if:

$$\frac{p ( s / {H}_{1} )}{p ( s / {H}_{0} )} > λ$$

The decision process may now be seen as comparing the likelihood of the value s being generated by altered image content, against the likelihood of it being generated by authentic content. The decision boundary is determined by the value of λ. Different values of λ result in different false alarm and detection probabilities, allowing a ROC curve to be plotted. Choosing a value for λ to give a specific false alarm probability therefore selects the operating point on the ROC curve. This approach is known as the Neyman-Pearson decision criterion, and can be shown to maximise the detection probability for a chosen probability of false alarm.

1. A method of verifying the authenticity of media content, said method comprising the steps of:
extracting a sequence of first authentication bits from said media content by comparing a property of the media content in successive sections of the media content with a second threshold,
receiving a sequence of second authentication bits, said received sequence being extracted from an original version of the media content by comparing said property of the media content with a first threshold, and
declaring the media content authentic if the received sequence of second authentication bits matches the extracted sequence of first authentication bits,
characterised in that the step of extracting the authentication bits from the media content comprises setting the second threshold in dependence upon the received authentication bits, such that the probability of an extracted authentication bit in said sequence of first authentication bits mismatching the corresponding received authentication bit in said sequence of second authentication bits is reduced compared with using the first threshold for said extraction.

2. The method according to claim 1, wherein the false alarm rate when verifying authenticity of said media content is reduced.

3. The method according to claim 1, wherein the step of extracting the authentication bits from the media content comprises controlling the threshold in dependence upon the received authentication bits such that the probability that an extracted authentication bit matches the corresponding received authentication bit is high.

4. The method according to claim 1 further comprising controlling the second threshold during the step of extracting the authentication bits based upon the current mismatching authentication bits, in such a manner that the authenticity decision process is adjusted according to previously thus far discovered mismatching authentication bits, leading to improved localisation of non-authentic section(s) in said media content.

5. The method according to claim 1, comprising declaring the media content as a whole tampered with, if the received sequence of second authentication bits does not match the extracted sequence of first authentication bits.

6. The method according to claim 5, wherein mis-matching bits between the received sequence of second authentication bits and the extracted sequence of first authentication bits comprise information on localisation of at least a first section in said media content, said method further comprising the step of identifying and/or marking the localisation of tampered sections in said media content for visualisation of at least one tampered section(s).

7. The method according to claim 6, further comprising subsequent phases in which the step of extracting is repeated using a modified second threshold.

8. The method according to claim 7, wherein said step of extracting is solely executed on sections of said media content neighbouring to sections of said media content being identified as tampered.

9. A method as claimed in claim 1, comprising further phases in which the step of extracting is repeated, the second threshold being controlled in dependence upon the distance between the section for which the authentication bit is extracted and sections for which it has been found that the authentication bits mismatch the received authentication bits.

10. The method according to claim 1, wherein the segments are blocks and the media content is a digital image,
wherein the step of extracting comprises making an authentication decision for each block independently and the second threshold is firstly derived from a low false alarm operating point,
wherein the step of declaring comprises declaring the image as authentic if no blocks are declared tampered or declaring the image as a whole being inauthentic if at least one tampered blocks are found,
wherein blocks neighbouring those that are tampered are declared having a higher probability of being tampered than non-neighbouring blocks, and new operating points are selected for remaining blocks, not being declared tampered in previous runs, for repeated authentication decisions until no further tampered blocks are identified.

11. The method according to claim 10, further using alterations to the decision boundary to move the operating point to a position with a larger detection probability.

12. The method according to claim 10, further comprising determining the full size and shape of a tampered image region by marking of tampered blocks in the image.

13. The method according to claim 1, wherein said adjusting of said second threshold comprises adjusting the operating point or the decision boundary or prior probabilities according to context information as given by a neighbouring decision.

14. The method according to claim 1, wherein the second threshold is adjusted according to the formula:
λᵢ=αλ1+(1−α)λ2,
wherein λ₁=1 and λ₂>1 are decision thresholds, and α is given by:
$$α = ( \frac{n}{m} ) ( \frac{ⅆ - rm}{ⅆ - 1} ) , and {r}_{m} = min ( r , d ) ,$$
wherein n is the number of blocks neighbouring block i that are marked as tampered, m is the total number of blocks neighbouring block i, r is the distance in units of blocks of block i from the closest tampered block, and d is the maximum distance that sets how widely around a tampered block that suspicion is raised,
wherein a subsequent authentication decision is re-evaluated using the new second threshold λᵢ, and
if further blocks are declared tampered in the subsequent authentication decision, the procedure of adjusting the second threshold and re-evaluating blocks, authenticity is repeated until no further tampered blocks are identified.

15. The method to claim 1, wherein the second threshold used to determine the authentication bits represents an operation point on a ROC curve.

16. Application of the method according to claim 1 in multimedia authentication decisions, wherein said multimedia comprises image or video and/or audio data.

17. Application according to claim 16, wherein said multimedia authentication decisions are applied in surveillance systems.

18. Application according to claim 16, wherein adjustment of a decision boundary in multimedia authentication decisions is based on context information.

19. Application according to claim 18, wherein said context information is based on proximity to areas already determined as tampered during tampering localisation of said multimedia.

20. A device (8) for verifying the authenticity of media content by performing the method according to claim 1, said device comprising
means (80) for extracting a sequence of first authentication bits from said media content by comparing a property of the media content in successive sections of the media content with a second threshold,
means (81) for receiving a sequence of second authentication bits, said received sequence being extracted from an original version of the media content by comparing said property of the media content with a first threshold, and
means (82) for declaring the media content authentic if the received sequence of second authentication bits matches the extracted sequence of first authentication bits,
characterised in that the means for extracting the authentication bits from the media content comprises means (83) for setting the second threshold in dependence upon the received authentication bits, such that the probability of an extracted authentication bit in said sequence of first authentication bits mismatching the corresponding received authentication bit in said sequence of second authentication bits is reduced compared with using the first threshold for said extraction.

21. A computer-readable medium (9) having embodied thereon a computer program for verifying the authenticity of media content by performing the method according to claim 1, and for processing by a computer (94), the computer program comprising
a first code segment (90) for extracting a sequence of first authentication bits from said media content by comparing a property of the media content in successive sections of the media content with a second threshold,
a second code segment (91) for receiving a sequence of second authentication bits, said received sequence being extracted from an original version of the media content by comparing said property of the media content with a first threshold, and
a third code segment (92) for declaring the media content authentic if the received sequence of second authentication bits matches the extracted sequence of first authentication bits,
characterised in that the code segment (90) for extracting the authentication bits from the media content comprises a code segment (93) for setting the second threshold in dependence upon the received authentication bits, such that the probability of an extracted authentication bit in said sequence of first authentication bits mismatching the corresponding received authentication bit in said sequence of second authentication bits is reduced compared with using the first threshold for said extraction.
